(19) United States
(12) Patent Application Publication
(10) Pub. No.: US 2021/0313613 A1
(43) Pub. Date: Oct. 7, 2021

(54) BATTERY FOR DELIVERING ELECTRICAL POWER

(71) Applicant: Vestel Elektronik Sanayi ve Ticaret A.S., Manisa (TR)

(72) Inventors: Kadir YILDIZ, Manisa (TR); Onur AKDEMÍR, Manisa (TR)

(21) Appl. No.: 17/268,879

(22) PCT Filed: Aug. 16, 2018
(86) PCT No.: PCT/EP2018/072245

§ 371 Date: Feb. 16, 2021

(51) Int. Cl. H01M 10/04; H01M 10/42; H01M 50/267; H01M 50/213

(52) U.S. Cl. CPC H01M 10/0445; H01M 10/425; H01M 50/267; H01M 2010/4271; H01M 10/0422; H01M 10/4221; H01M 50/213

(57) ABSTRACT

A battery for delivering electrical power at a battery voltage has a body having a first end and a second end. A first terminal of a first polarity is provided at the first end and a second terminal of a second polarity provided at the second end. The body is expandable and collapsible along its length so as to move the first terminal and the second terminal apart from each other and closer to each other respectively so as to change the length of the battery. The battery has the circuitry arranged to set the battery voltage in accordance with the length of the battery.

### CROSS REFERENCE TO RELATED APPLICATION

This application is a US 371 application from PCT/EP2018/072245 entitled “BATTERY FOR DELIVERING ELECTRICAL POWER” filed on Aug. 16, 2018 and published as WO 2020/035144 A1 on Feb. 20, 2020. The technical disclosures of every application and publication listed in this paragraph are hereby incorporated herein by reference.

### TECHNICAL FIELD

The present disclosure relates to a battery for delivering electrical power.

### BACKGROUND

Batteries are manufactured and supplied in a large number of standard types. The different standard types in general have different shapes and sizes and deliver electrical power at one specific voltage or another. It is often the case that a particular device or apparatus requires one or more batteries that are of one specific type and cannot accommodate batteries that are of a different type. This is inconvenient for consumers as it means that they have to purchase and typically also stock a number of batteries of different types for different devices.

### SUMMARY

According to an aspect disclosed herein, there is provided a battery for delivering electrical power at a battery voltage, the battery comprising:

a body having a first end and a second end;

a first terminal of a first polarity at the first end;

a second terminal of a second polarity at the second end; and

circuitry;

the body being expandable and collapsible along its length so as to move the first terminal and the second terminal apart from each other and closer to each other respectively so as to change the length of the battery; and

the circuitry being arranged to set the battery voltage in accordance with the length of the battery.

This provides a configurable battery which can be adjusted in length according to the size of some battery holder or receptacle or the like in which the battery may be mounted in use. The body may be manually expandable and collapsible, such that a user can adjust the length of the battery by hand. The voltage supplied by the battery can automatically adjust depending on the length of the battery. Some specific examples of this will be discussed further below.

In an example, the battery comprises a sensor arranged to provide a measure of the length of the battery to the circuitry, the circuitry being arranged to set the battery voltage in accordance with the measured length of the battery.

In an example, the sensor is a proximity sensor.

In an example, the circuitry is arranged to set the battery voltage to be around 1.5 V in the case that the length of the battery is greater than around 30 mm and to set the battery voltage to be around 12 V in the case that the length of the battery is less than around 30 mm.

In an example, the body is expandable and collapsible so as to change the length of the battery to be selectively the same as the length of a battery of type AAAA, AAA, AA, A, C, D, A23 and A27. AAAA, AAA, AA, A, C and D batteries all provide a voltage of 1.5 V, whereas A23 and A27 batteries provide a voltage of 12 V.

In an example, the battery is arranged such that the length of the battery is a maximum when the battery is in its rest state. That is, if no force is being applied to the battery, in particular no force is being applied to the body, then the length of the battery is a maximum.

In an example, the body is expandable and collapsible across its width.

In another example, the body is not expandable or collapsible across its width.

There may also be provided in combination, a carrier and a battery as described above, the carrier having an outer wall defining the width of the carrier and having a hollow interior in which the battery can be received.

In this example, the expandable/collapsible battery may have a width that is the narrowest of the types of battery that are to be “mimicked” or achieved by the expandable/collapsible battery. If the expandable/collapsible battery is to be received in some battery holder or receptacle that requires the battery to have a greater width than the width of the battery, the battery can be inserted into the carrier which then takes up the space.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example of a battery according to the present disclosure in a first configuration;

FIG. 2 shows schematically the battery of FIG. 1 in a second configuration;

FIG. 3 shows schematically examples of standard battery types;

FIG. 4 shows schematically another example of a battery according to the present disclosure;

FIG. 5 shows schematically an example of a battery and a carrier according to the present disclosure; and,

FIG. 6 shows schematically an example of a battery according to the present disclosure with an example of circuitry for use in the battery.

### DETAILED DESCRIPTION

As mentioned and as is well known, batteries are manufactured and supplied in a large number of standard types. This is inconvenient for users.

In examples described herein, a battery is provided in which the length of the battery can be adjusted and the voltage delivered by the battery is set in accordance with the length of the battery. This provides users with an adjustable battery that can set the battery voltage as appropriate for the battery type that is being “mimicked” or achieved.

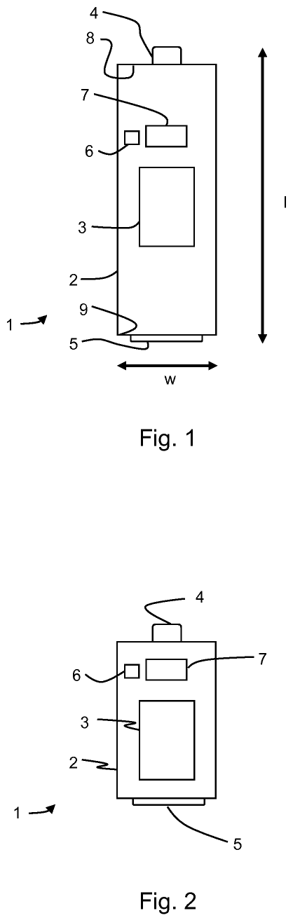

Referring now to FIGS. 1 and 2, these show an example of a battery 1 according to the present disclosure in a first, expanded configuration and a second, collapsed configuration respectively. The battery 1 is generally cylindrical having a length 1 and a width w. In this example, the cross-sectional shape of the battery 1 is circular, such that in this example the “width” is the diameter of the battery 1.

The battery 1 has a body 2. The body 2 is expandable and collapsible along the length of the battery 1. The body 2 in this example is manually expandable and collapsible so that a user can expand and collapse the battery 1 by hand. Examples of arrangements for the body 2 that enable the expansion and collapse will be discussed below.

The battery 1 contains an electrochemical cell 3 within the body 2. The electrochemical cell 3 generates electrical power in a manner known per se. The electrochemical cell 3 may be of the single-use type in the case that the battery 1 is a “primary” or “disposable” battery or may be rechargeable in the case that the battery 1 is a “secondary” or rechargeable battery. The battery 1 has a first terminal 4 at one end and a second terminal 5 at the other end. The first terminal 4 may be of the “nub” type and is commonly the positive terminal. The second terminal 5 may be of the flat disk type and is commonly the negative terminal. The first and second terminals 4, 5 are in electric communication with the electrochemical cell 3. The connections between the electrochemical cell 3 and the first and second terminals 4, 5 may be achieved by for example flexible connecting wires (not shown) which maintain the electrical connection as the battery 1 is expanded or collapsed.

The battery 1 of this example further has a sensor 6 for obtaining a measure of the length of the battery 1 and which is in communication with circuitry 7 which will be discussed further below. The sensor 6 may for example be located on top of the cell 3 and can measure the distance between the top of the cell 3 and the internal wall 8 at the top of the body 2 of the battery 1 (i.e. near the positive terminal 4). This may be suitable in the case that only the upper part of the body 2 is expandable and collapsible. Alternatively, the sensor 6 may for example be located on the bottom of the cell 3 and can measure the distance between the bottom of the cell 3 and the internal wall 9 at the bottom of the body 2 of the battery 1 (i.e. near the negative terminal 5). This may be suitable in the case that only the lower part of the body 2 is expandable and collapsible. In the example shown, the sensor 6 is positioned within the body 2 to provide a measure of the distance between the upper and lower internal walls 8, 9 of the body 2. This is particularly suitable in the case that the body 2 can expand at the top and bottom or, more generally, anywhere along its length. In another example, there may be sensors 6 at the top and bottom of the cell 5 for measuring the distances from the cell to the top and bottom of the body 2 respectively.

The sensor 6 may be for example a proximity sensor. The proximity sensor 6 may be for example an optical sensor, such as a photoelectric proximity sensor, a capacitive proximity sensor, an inductive proximity sensor, etc. Proximity sensors 6 can typically provide a measure of the length of the battery 1 with high accuracy. As an alternative to use of a proximity sensor, the sensor 6 may be a slide potentiometer or some other type of sensor.

The circuitry 7 is contained within the body 2 of the battery 1. A specific example of suitable circuitry 7 will be discussed further below. The circuitry 7 receives a measure of the length of the battery 1 from the sensor 6. The circuitry 7 can set the output voltage that is delivered by the battery 1 in use as necessary based on the length of the battery 1.

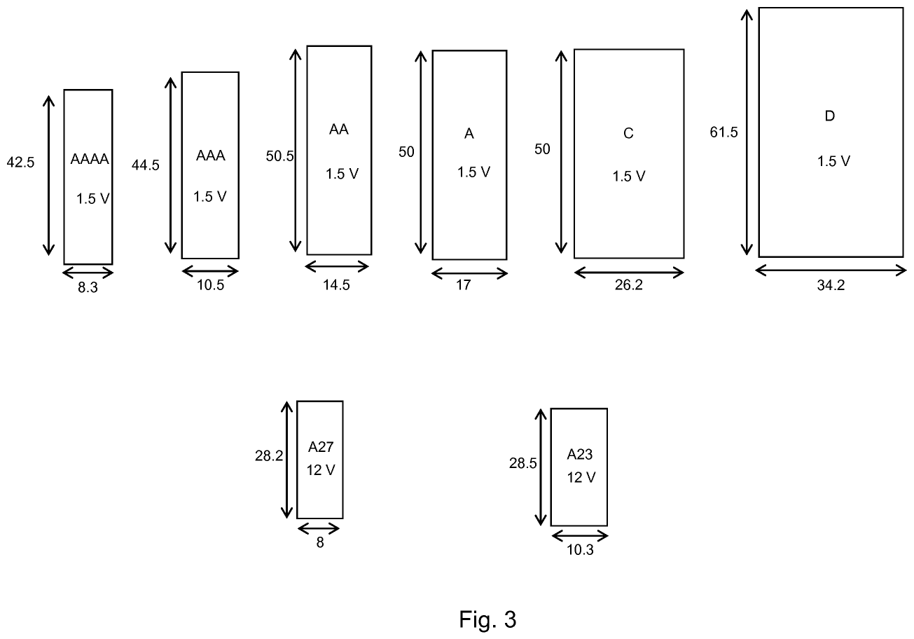

An example of the different types of battery that can be “mimicked” or effectively achieved by the battery 1 is summarised in Table 1 and shown graphically in FIG. 3. In FIG. 3, as in Table 1, dimensions are given in millimetres. Moreover, the indicated voltage is the nominal voltage supplied by the battery 1, it being understood that the actual voltage that is delivered by a battery can change over time, for example as the electrochemical cell depletes with use.

TABLE 1

| Type | Diameter (mm) | Length (mm) | Voltage | |
|---|---|---|---|---|
| AAAA | 8.3 | 42.5 | 1.5 | V |
| AAA | 10.5 | 44.5 | 1.5 | V |
| AA | 14.5 | 50.5 | 1.5 | V |
| A | 17 | 50 | 1.5 | V |
| C | 26.2 | 50 | 1.5 | V |
| D | 34.2 | 61.5 | 1.5 | V |
| A23 | 10.3 | 28.5 | 12 | V |
| A27 | 8 | 28.2 | 12 | V |

The circuitry 7 is configured such that if the battery 1 is mimicking a battery of type AAAA, AAA, AA, A, C or D, then the battery 1 is caused to deliver a (nominal) voltage of 1.5 V. On the other hand, if the battery 1 is mimicking a battery of type A23 or A27, then the circuitry 7 operates so that the battery 1 is caused to deliver a (nominal) voltage of 12 V. This is particularly convenient for the user as the battery 1 not only allows different sizes of battery to be obtained, but the battery 1 also adjusts the voltage that is delivered by the battery 1 as necessary.

The circuitry 7 may be arranged such that if the battery 1 has a length greater than for example 30 mm, then the battery 1 is configured to deliver a voltage of 1.5 V, whereas if the length is less than for example 30 mm, then the battery 1 is configured to deliver a voltage of 12 V. The threshold length may be different. For example, a threshold length of for example 35 mm or so allows a greater margin of error in the measure of the length of the battery 1. A threshold length of up to around 40 mm may be used in other examples.

A number of different arrangements that enable the battery 1 to be expandable and collapsible are possible.

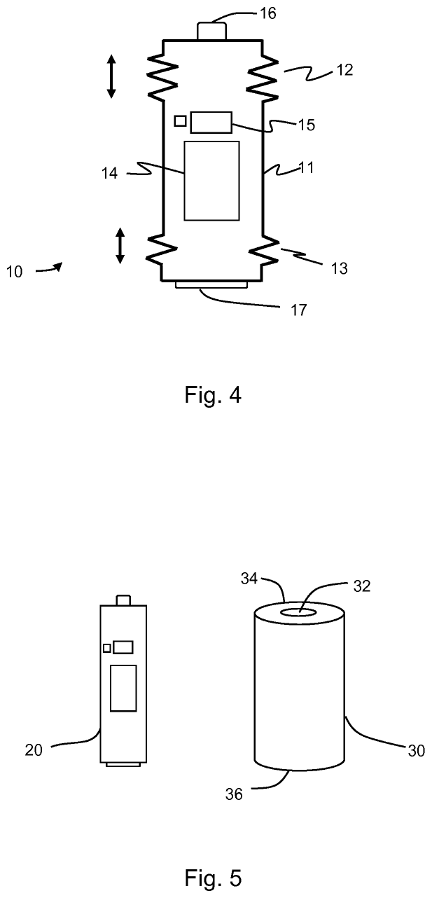

For example, the body 2 of the battery 1 may have one or more “concertina” (or zig-zag or accordion or “z”) sections, having multiple folds which allow the section to expand or contract. An example of this is shown schematically in FIG. 4. In the example of FIG. 4, the battery 10 has a body 11 having two concertina sections 12, 13. The first concertina section 12 is provided towards the upper part of the body 11, between the battery cell 14/circuitry 15 and the upper, positive terminal 16. The second concertina section 13 is provided towards the lower part of the body 11, between the battery cell 14/circuitry 15 and the lower, negative terminal 17. The concertina sections 12, 13 allow a user to manually expand and collapse the battery 1 along its length as required.

In another example (not shown), the battery may have a body that is partially or completely formed of a “memory foam”, such as for example a viscoelastic polyurethane foam. This again enables to manually expand and collapse the battery along its length as required.

In some examples, the battery is arranged so that its length is a maximum when it is in its rest state. That is, if no force is being applied to the battery, in particular if no force is being applied to the body, then the length of the battery is a maximum. In such cases, the user only needs to collapse or contract the body to achieve a battery of shorter length, and can allow the battery to relax to its maximum length for the longest length of battery that is required.

In some examples, the battery is expandable and collapsible along its length and is also expandable and collapsible across its width. This enables the battery itself to accommodate more closely a range of “standard” battery sizes.

In other examples, the battery is only expandable and collapsible along its length and is not expandable or collapsible across its width. That is, in this example the body is sufficiently rigid that a user cannot normally manually collapse or expand the body across its width. An advantage of this is that the battery itself may be simpler to manufacture than a battery that is expandable and collapsible across its width.

In any of these examples, the battery may be used in conjunction with a carrier. An example of this is shown schematically in FIG. 5. In FIG. 5, there is shown to the left side an elevation of a battery 20 that is expandable and collapsible along its length but not (necessarily) across its width. On the right side of FIG. 5 is shown a perspective view of a carrier 30 for receiving the battery 20. The carrier 30 is generally sleeve-like, being cylindrical and having a hollow interior 32. At least one of the opposed ends 34, 36 of the carrier 30, and in some examples both of the opposed ends 34, 36 of the carrier 30, are open to permit the battery 20 to be inserted into and removed from the hollow interior 32 of the carrier 30. The carrier 30 enables the effective width of the battery 20 to be increased.

In the case that the battery 20 is not expandable or collapsible across its width, then the battery 20 may be formed to have a width that is the narrowest of the types of battery that are to be mimicked or achieved by the expandable/collapsible battery. Referring to Table 1, in a specific example, the width of the battery may be around 8 mm, corresponding to batteries of AAAA or A27 type. The battery 20 can then be inserted into the carrier 30 to obtain a greater effective width.

Such a carrier 30 may be useful even if the battery 20 is expandable and collapsible across its width as it allows a wider range of battery widths to be effectively achieved and accommodated without requiring the body of the battery 20 to undergo large changes in width. The hollow interior 32 of the carrier 30 may have a width (or diameter) that is slightly less than the width of the battery 20 in its rest state. In such a case, the user can compress the battery 20 across its width to fit the battery 20 into the carrier 30. The battery 20 can then relax, causing its width to expand such that it is held firmly in the carrier 30.

The carrier 30 may be substantially rigid, in particular rigid enough that it does not compress under the application of a normal force by a user. In other examples, the carrier 30 itself may be expandable and collapsible, especially across its width. This further extends the range of sizes, in particular the range of widths, that can be effectively achieved with the combination of the battery 20 and the carrier 30.

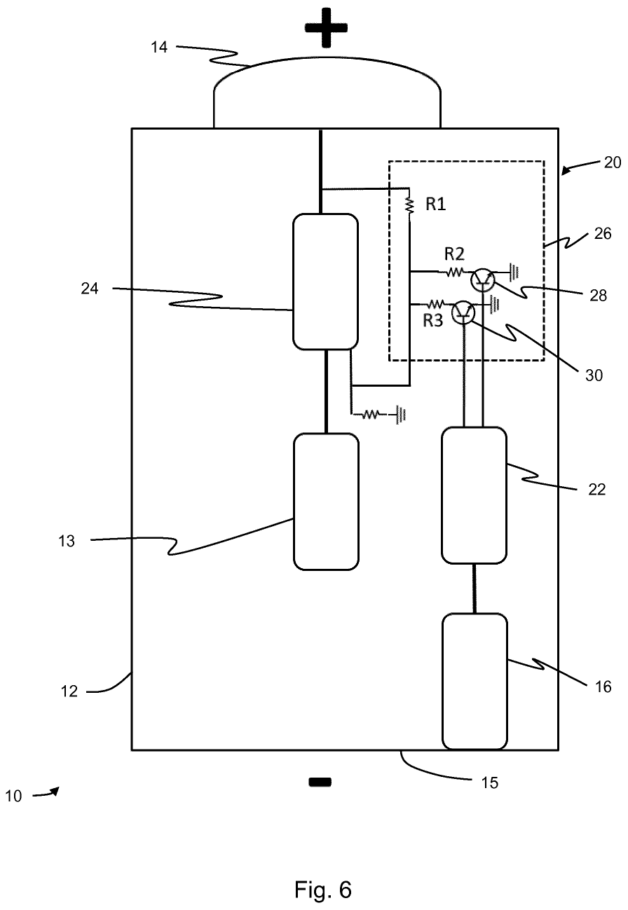

Referring to FIG. 6, this shows schematically an example of a battery 10 according to the present disclosure with an example of circuitry 20 for use in the battery 10. The battery 10 of this example may be generally similar to and in accordance with the examples described above, and the description of the various similar components will not be repeated here in detail.

Briefly and similarly to the examples discussed above, the battery 10 has a body 12, which is expandable and collapsible along the length of the battery 10. The battery 10 contains an electrochemical cell 13 within the body 12. The battery 10 has a first terminal 14 at one end and a second terminal 15 at the other end. The battery 10 of this example has a sensor 16, which may be for example a proximity sensor, for obtaining a measure of the length of the battery 10.

The circuitry 20 is contained within the body 12 of the battery 10. The circuitry 20 of this example includes a controller unit 22, a power converter block 24 and a switch circuit block 26. The controller unit 22 may for example be or include a processor, such as for example a programmable system-on-chip or SOC. Programmable SOCs can be very small and are suitable to be located inside the body 12 of the battery 10.

As discussed above, the sensor 16 obtains a measurement of the length of the battery 10. In the example shown in FIG. 6, the proximity sensor 16 is located towards one end of the battery 10 (i.e. near the negative terminal 15 in this example) and measures the distance to the other end of the battery 10 (i.e. near the positive terminal 14 in this example). During the manufacturing production or calibration stage of the batter 10, the sensor 16 can measure the length of the battery 10 for all types of batteries to be “mimicked” by the expandable/collapsible battery. The measurements can be permanently stored in the software of the controller 22. Likewise, the voltage values corresponding to these lengths can also be permanently stored in the software of the controller 22.

In use, the sensor 16 measures the length of the battery 10 and sends the measurement data to the controller 22. The controller 22 then compares the measured length value with the stored voltage-length values and determines the battery type and desired voltage level. The controller 22 can then control the switch circuit block 26 so that the power converter block 24 of the battery 10 outputs the correct, corresponding voltage.

In an example, the power converter block 24 includes a power converter integrated circuit or IC. The voltage output by the IC of the power converter block 24 can be controlled by a feedback pin which is controlled by the switch circuit block 26.

For this, the switch circuit block 26 of this example has two transistors 28, 30 which operates as switches under control of the controller 22 which provides control signals (voltage) to the bases of the transistors 28, 30. A first resistor R1 is provided in the feedback circuit of the power converter 24. Second and third resistors R2, R3 are respectively provided between the collectors of the transistors 28, 30 and the feedback circuit and the emitters of the transistors 28, 30 are connected to earth (e.g. the body 12 of the battery 10). The values of the resistors R1, R2 and R3 are set so that the desired output voltage from the power converter block 24 is achieved, depending on the battery type as determined from the length of the battery 10 by the controller 22 in conjunction with the sensor 16.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A battery for delivering electrical power at a battery voltage, the battery comprising:
a body having a first end and a second end;
a first terminal of a first polarity at the first end;
a second terminal of a second polarity at the second end; and
circuitry;
the body being expandable and collapsible along its length so as to move the first terminal and the second terminal apart from each other and closer to each other respectively so as to change the length of the battery; and
the circuitry being arranged to set the battery voltage in accordance with the length of the battery.

2. The battery according to claim 1, comprising a sensor arranged to provide a measure of the length of the battery to the circuitry, the circuitry being arranged to set the battery voltage in accordance with the measured length of the battery.

3. The battery according to claim 2, wherein the sensor is a proximity sensor.

4. The battery according to claim 1, wherein the circuitry is arranged to set the battery voltage to be around 1.5 V in the case that the length of the battery is greater than around 30 mm and to set the battery voltage to be around 12 V in the case that the length of the battery is less than around 30 mm.

5. The battery according to claim 1, arranged such that the length of the battery is a maximum when the battery is in its rest state.

6. The battery according to claim 1, wherein the body is expandable and collapsible across its width.

7. The battery according to claim 1, wherein the body is not expandable or collapsible across its width.

8. A system comprising a carrier and the battery according to claim 1, the carrier having an outer wall defining the width of the carrier and having a hollow interior in which the battery can be received.
